(19) United States
(12) Patent Application Publication
(10) Pub. No.: US 2015/0023670 A1
(43) Pub. Date: Jan. 22, 2015

(54) METHOD AND SYSTEM FOR INTERACTIVE COMMUNICATIONS

(71) Applicant: George Bacon, San Diego, CA (US)

(72) Inventor: George Bacon, San Diego, CA (US)

(21) Appl. No.: 13/946,290

(22) Filed: Jul. 19, 2013

(51) Int. Cl. H04B 10/11; H04W 4/16

(52) U.S. Cl. CPC H04B 10/11; H04W 4/16
USPC 398/130

(57) ABSTRACT

A method for interaction among individuals using mobile communication devices equipped with lasers and optical receivers without requiring use of mobile numbers. An initial message is either communicated in full directly from sending to receiving device or alternatively message contents are first uploaded to a common application server and a unique identification code is transmitted to the receiving device and used to retrieve the full message from the server. The method of transmission by sender device to be optical or infrared laser and received by devices equipped with an optical or infrared receivers. Interactions subsequent to the initial message may not require use of a laser and can be facilitated via the common application servers without any requirement for parties to divulge personal identifying information. Such initial interaction by method thus described may require permission from, or be limited by, venue operators or jurisdictional governance.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to wireless communication. More particularly, the invention relates to wireless communication through use of lasers.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Though several currently available electronic devices facilitate communication, most require users to exchange personal information prior to engaging in communication.

One currently known solution shows a remote assistance system which may transmit images or other visual data to a mobile phone, the visual data then being overlaid upon images presented on the mobile phone. Another known solution teaches of a method or providing near simultaneous night vision and communication including directing a narrow voice modulated infrared laser beam at a distant receiver/demodulator during communication periods. Yet another known solution discloses of a wireless communications device which may incorporate laser pointer circuitry. However, these solutions may be ineffective for allowing strangers in close proximity to each other to engage in conversation prior to exchanging personal information.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary device incorporating means of communication with a laser, in accordance with an embodiment of the present invention;

FIG. 2 illustrates an exemplary network for facilitating communication, in accordance with an embodiment of the present invention;

FIG. 3 illustrates an exemplary method for sending data by means of a laser, in accordance with an embodiment of the present invention;

FIGS. 4A and 4B illustrate an exemplary method for receiving data transmitted by laser, in accordance with an embodiment of the present invention;

FIG. 5 is a block diagram depicting an exemplary client/server system which may be used by an exemplary web-enabled/networked embodiment of the present invention; and

FIG. 6 illustrates a block diagram depicting a conventional client/server communication system.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be plain text or formatted to conform to a protocol such as Simple Object Access Protocol (SOAP) or JavaScript Object Notation (JSON) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

Embodiments of the present invention provide means and methods for facilitating communication through use of electronic devices.

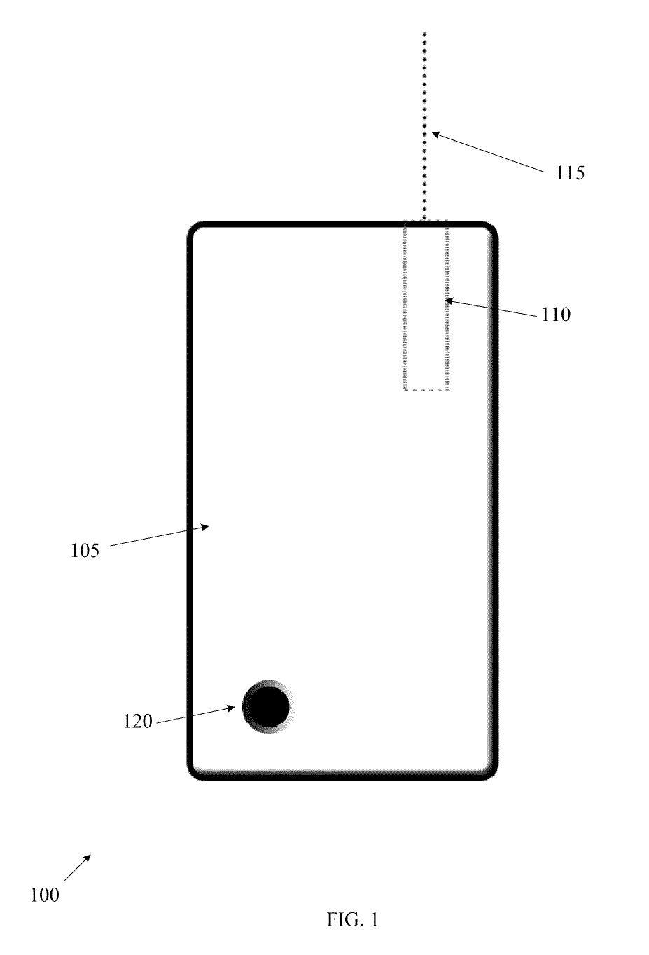

FIG. 1 illustrates an exemplary device incorporating means of communication with a laser, in accordance with an embodiment of the present invention. In the present embodiment, an electronic device 105 may house a laser 110. In some embodiments, suitable electronic devices 105 may include, without limitation, cell phones, smartphones, tablets, and computers. In many embodiments, laser 110 may be of any type and/or specification, including, without limitation, a low power laser 110. In alternative embodiments, a narrow beam infrared (IR) light-emitting diode (LED) may be used. In the present embodiment, laser 110 may emit a beam 115. In some embodiments, beam 115 may have frequency within visual spectrum to allow users to view beam 115. In alternative embodiments, beam 115 may have frequency outside of visual spectrum. In some embodiments, laser 110 may transmit data by way of, without limitation, analog and/or pulse signal. In many embodiments, data may be transmitted continuously in a repeating loop. In the present embodiment, device 105 may house an optical receiver 120. In some embodiments, optical receiver 120 may be suitable to receive data from only certain types of lasers. In other embodiments, a generic optical receiver 120 may be used, which may be suitable to receive any kind of laser. In alternative embodiments, laser 110 and/or optical receiver 120 may be separate devices from the electronic device 105. In some of these alternative embodiments, laser 110 and/or optical receiver 120 may connect to a device 105. In other of these alternative embodiments, laser 110 and/or optical receiver 120 may communicate wirelessly with device 105.

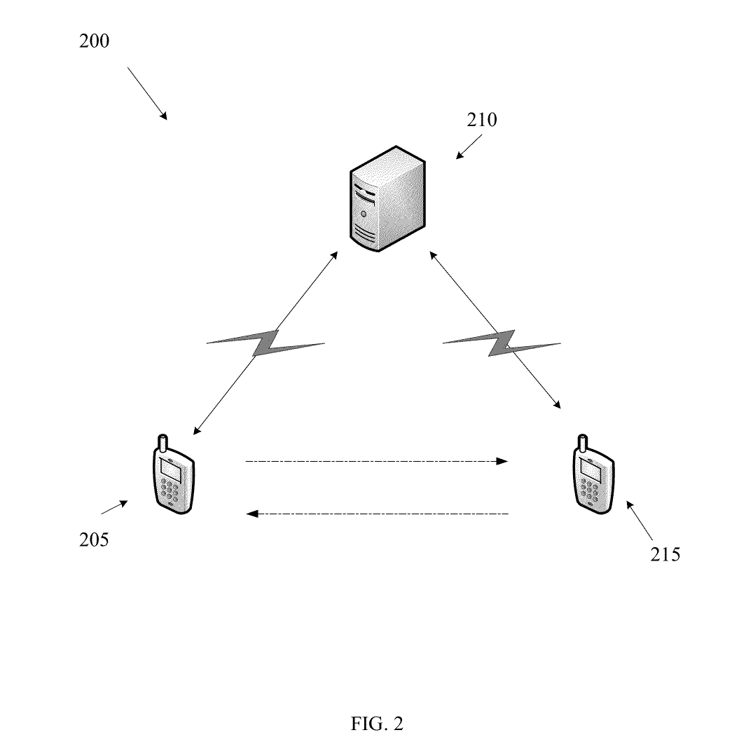

FIG. 2 illustrates an exemplary network for facilitating communication, in accordance with an embodiment of the present invention. In the present embodiment, a sender device 205 may communicate bi-directionally with one or more common application servers 210. Further, in the present embodiment, the application server 210 may communicate bi-directionally with a recipient device 215, thereby allowing communication between sender device 205 and recipient device 215. Communication between the application server 210 and the sender device 205 and the recipient device 215 may be by any means including, but not limited to, cellular network, Wi-Fi, any wireless or combination of wireless and wired connection. The sender device 205 and the recipient device 215 may signal each other via optical beams such as, but not limited to, LED infrared or visible laser beam, with subsequent communication by optical beam or via common application server.

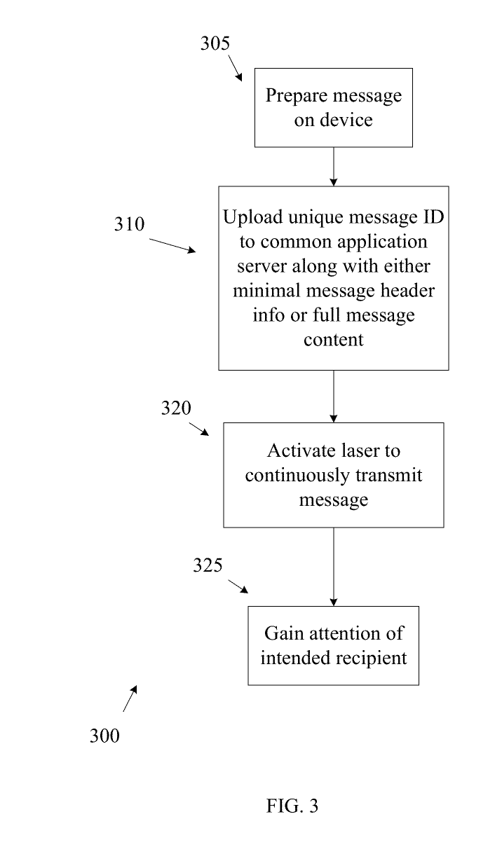

FIG. 3 illustrates an exemplary method for sending data by means of a laser, in accordance with an embodiment of the present invention. In the present embodiment, a user may prepare a message on user's device 105 in a step 305. In many embodiments, during composition of a message, message data, including, without limitation, identification data may be uploaded to server 210. In some embodiments, message may include, without limitation, text, images, videos, audio selections, etc. In a non-limiting example, message may contain text along with a profile image of sender. In some embodiments, message may also include, without limitation, an invitation to participate in an interactive service. In some of these embodiments, interactive service may include, without limitation, a virtual interface platform. In the present embodiment, user's device 105 may upload, to server 210, a unique message ID along with either a minimal message header information or full message content in a step 310. In alternative embodiments, users may upload identifying message details to server 210 even if an invitation may not be included in message. In some embodiments, identifying message details may include, without limitation, user contact information, images, videos, audio selection, etc. In a non-limiting example, a user may upload user's phone number to provide number to recipients of a message. In one minimal laser transmission embodiment, the pertinent message details may be first or simultaneously uploaded from the sender's device to the common application server with only a unique message ID being transmitted by laser to the intended recipient device which can then contact the common application server to determine the type of message and allow the receiver to download the full message content or otherwise interact with the sender if desired. In the present embodiment, a message may be continuously transmitted by means of laser in a step 320. In other alternative embodiments the message may be transmitted in a burst mode. Further, in the present embodiment, user may apply any available means of attracting intended recipient's attention in a step 325. In a non-limiting example, user may employ a laser 110 having frequency within visual spectrum to allow intended recipient to see beam 115. In alternative embodiments, users may employ, without limitation, a narrow beam IR LED to put an IR cone on recipient and/or recipient's device 105. In the present alternative embodiment, IR LED may trigger recipient's device 105 to alert recipient of transmitted message.

In an alternative embodiment user's device 105 may employ a camera and a pattern recognition application. The pattern recognition application may recognize a person's features and disable the laser beam if it should land on or near the person's head to mitigate possible eye damage from the laser. In other alternate embodiments the pattern recognition application may recognize optical receiver 120 of recipient's device 105 and employ a targeting system to aid the user in directing the beam 115. In some alternate embodiments the laser may be a low power as to mitigate the risk of injury to eyes.

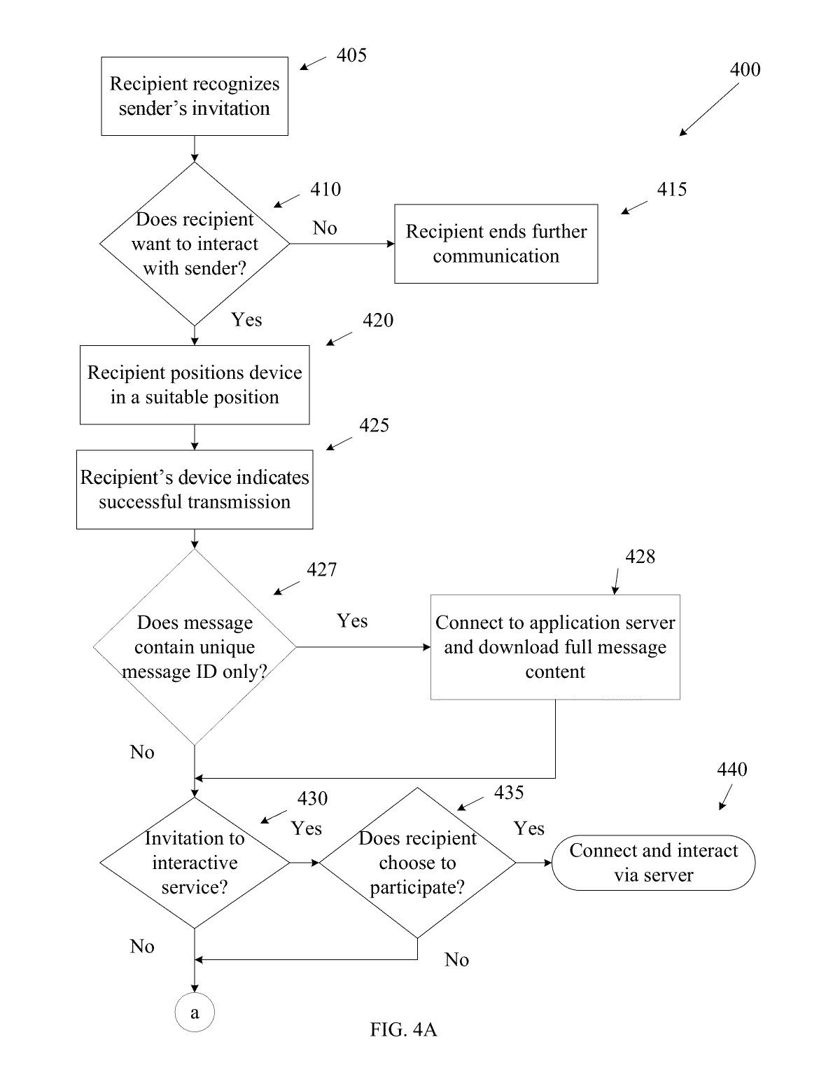

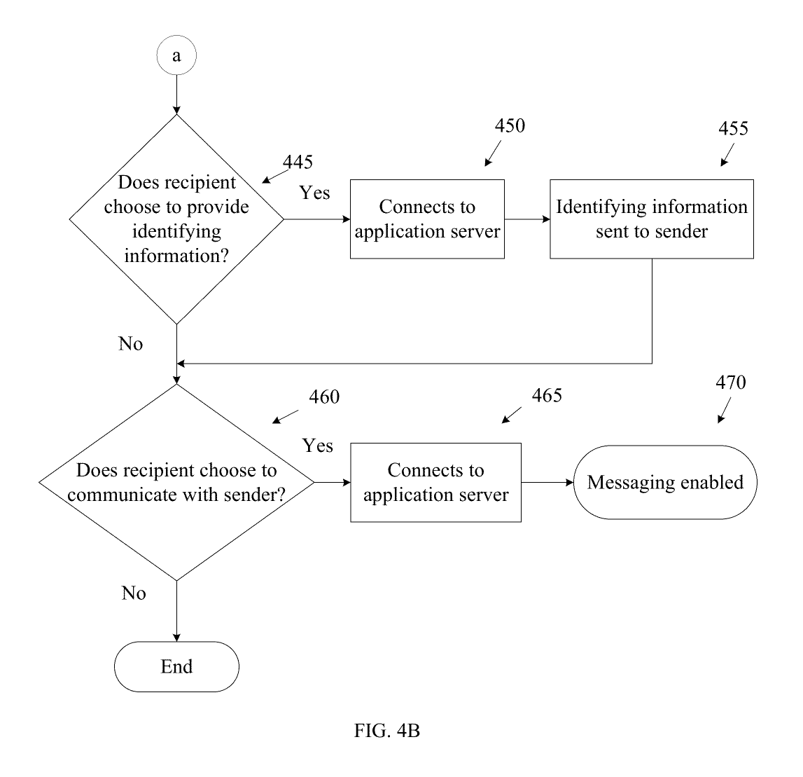

FIGS. 4A and 4B illustrate an exemplary method for receiving data transmitted by laser, in accordance with an embodiment of the present invention. Referring to FIG. 4A, in the present embodiment, a recipient may recognize a sender's invitation in a step 405. Further, in the present embodiment, recipient may choose whether to interact with sender in a step 410. Still further, in the present embodiment, if recipient does not want to interact with sender, recipient may cut off further communication in a step 415. In some embodiments, recipient may passively cut off communication by ignoring sender's invitation. In other embodiments, recipient may proactively cut off communication by physically waving off sender. In alternative embodiments in which recipient's device 105 may alert recipient of invitation, recipient may cut off communication by selecting an option on recipient's device 105 to ignore sender's invitation. In some of these alternative embodiments, sender may be alerted on sender's device 105 that recipient may have ignored sender's invitation. In the present embodiment, recipient may position recipient's device 105 to receive sender's transmitted message in a step 420. In a non-limiting example, recipient may position recipient's device 105 in such a way that optical receiver 120 on recipient's device 105 may be in path of beam 115 from sender's device 105. In the present embodiment, recipient's device 105 may alert recipient and/or sender of a successful transmission in a step 425. In some embodiments, device 105 may alert sender and/or recipient of, without limitation, failed transmission, lost transmission, or momentarily cut-off transmission. In a non-limiting example, screen on recipient's device 105 may flash green as visual indicator of successful transmission. In a non-limiting example, upon receiving the message, the recipient's device may communicate a successful message transmission to the common application server which would in turn communicates success of the transmission to the sender. In some embodiments, recipients of messages may be able to view message as well as sender's identifying information in any form, including, without limitation, a profile page. In the present embodiment, the system may determine if the received transmission contains the full message. If the message is not complete and only contains minimal information, such as, but not limited to, a unique message ID, recipient's device 105 may connect to the common application server to download the full message content. In the present embodiment, system may determine whether sender's message includes an invitation to participate in an interactive service in a step 430. In a non-limiting example, an interactive service hosted on the common application server may be a multi-participant platform with the possibility of allowing newly invited participants to themselves invite others. In the present embodiment, recipient may choose whether or not to participate in interactive service in a step 435. Further, in the present embodiment, if recipient chooses to participate in interactive service, recipient may connect to a common application server 210 and interact with sender in a step 440. Referring to FIG. 4B, in the present embodiment, recipient may choose whether or not to provide identifying information to sender in a step 445, while still agreeing to otherwise interact with the sender. Further, in the present embodiment, if recipient chooses to provide identifying information to sender, recipient may connect to an application server 210 in a step 450. In some embodiments, original message details may be used to determine identity of sender. In the present embodiment, recipient's identifying information may be sent to sender in a step 455. In alternative embodiments, recipient's identifying information may be sent to sender by any available method, including, without limitation, text message, email, standardized e-card via mobile application or external website. In the present embodiment, recipient may choose whether or not to continue communication with sender in a step 460. In some embodiments, users may interact through service without disclosing identities, possibly achieving anonymity by assuming a pseudo named and/or rendered character avatar. In the present embodiment, if recipient chooses to continue communication with sender, recipient may connect to an application server 210 in a step 465. Further, in the present embodiment, messaging may be enabled between sender and recipient in a step 470. In some embodiments, messaging may take place via one or more common application servers 210.

In many embodiments of the present invention, software may be available as a mobile application which users may download to electronic device, including, without limitation, cell phones, smartphones, tablets, and computers. In some embodiments, senders and recipients may interact through cellular devices 105 without needing phone numbers.

In some alternative embodiments, device 105 may house multiple lasers 110 and/or LEDs to allow multiple types and/or sizes of beams 115. In a non-limiting example, a narrow laser 110 and/or LED may be used to target an individual recipient, whereas a wider LED beam may be used to target a group of people (i.e. a group sitting at a table). In the present non-limiting example, wider LED beam may allow degree angles of 5-10 degrees. In another alternate embodiment a wider LED beam may be used to alert a recipient's device 105 and a narrower laser may transmit the message when the devices are aligned.

In a non-limiting example, a large group of users may congregate in an area and interact within an interactive virtual service, including, without limitation, social platforms, gaming platforms, and commerce platforms on a temporary or permanent basis through use of embodiments of the present invention. In the present non-limiting example, users may communicate and exchange data through use of lasers without requiring cellular phone numbers or other identifying information.

In some embodiments, venue operators or jurisdictions may either prevent or otherwise limit use of embodiments of the present invention within venue or jurisdictional bounds including, without limitation, possibly charging a fee for using said invention within venue or jurisdictional bounds. In a non-limiting example, a venue operator in a large venue may be concerned about the use of the present invention and potential interference with on stage performances, particularly the use of lasers in the visual spectrum. Built into the device application and central server software may be logic to detect intentions to utilize the invention within the bounds of a venue wishing to control such usage. A venue operator may have access to the central application server to either prevent usage outright or set bounds for the usage and possibly even charge a fee for using the invention within venue bounds. The limits set by the venue operator may even be as precise as limiting the angle or direction that beams may be pointed as further insurance against interfering with on stage performances

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

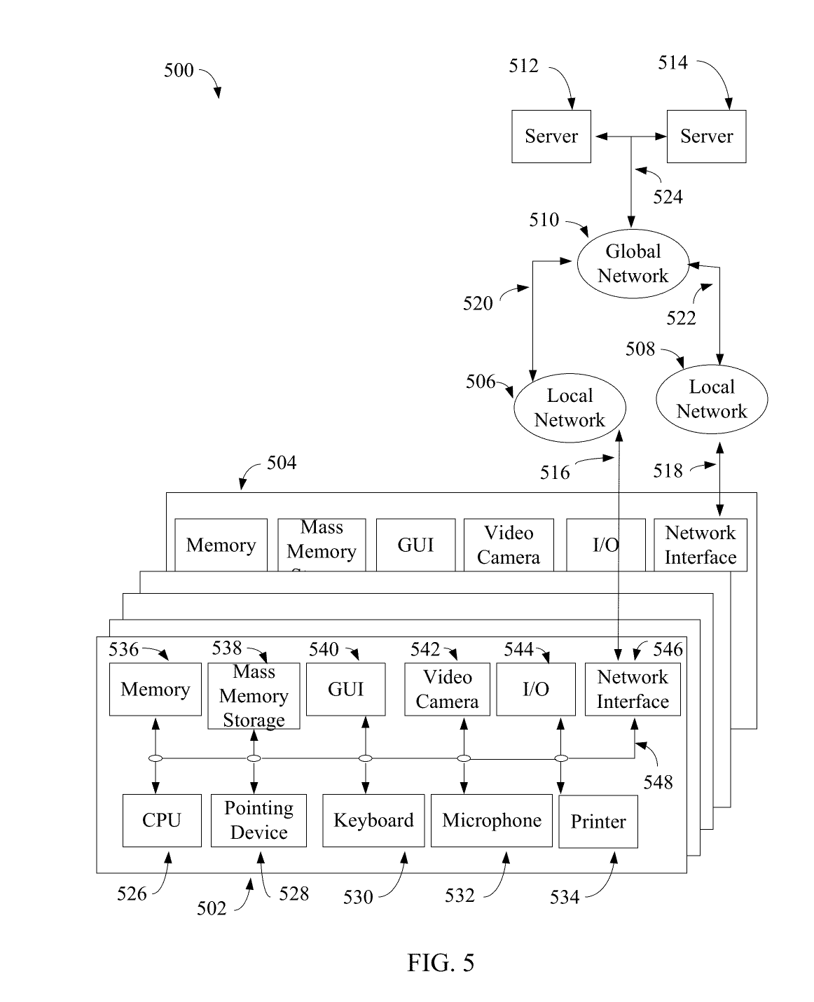

FIG. 5 is a block diagram depicting an exemplary client/server system which may be used by an exemplary web-enabled/networked embodiment of the present invention.

A communication system 500 includes a multiplicity of clients with a sampling of clients denoted as a client 502 and a client 504, a multiplicity of local networks with a sampling of networks denoted as a local network 506 and a local network 508, a global network 510 and a multiplicity of servers with a sampling of servers denoted as a server 512 and a server 514.

Client 502 may communicate bi-directionally with local network 506 via a communication channel 516. Client 504 may communicate bi-directionally with local network 508 via a communication channel 518. Local network 506 may communicate bi-directionally with global network 510 via a communication channel 520. Local network 508 may communicate bi-directionally with global network 510 via a communication channel 522. Global network 510 may communicate bi-directionally with server 512 and server 514 via a communication channel 524. Server 512 and server 514 may communicate bi-directionally with each other via communication channel 524. Furthermore, clients 502, 504, local networks 506, 508, global network 510 and servers 512, 514 may each communicate bi-directionally with each other.

In one embodiment, global network 510 may operate as the Internet. It will be understood by those skilled in the art that communication system 500 may take many different forms. Non-limiting examples of forms for communication system 500 include local area networks (LANs), wide area networks (WANs), wired telephone networks, wireless networks, or any other network supporting data communication between respective entities.

Clients 502 and 504 may take many different forms. Non-limiting examples of clients 502 and 504 include personal computers, personal digital assistants (PDAs), cellular phones and smartphones.

Client 502 includes a CPU 526, a pointing device 528, a keyboard 530, a microphone 532, a printer 534, a memory 536, a mass memory storage 538, a GUI 540, a video camera 542, an input/output interface 544 and a network interface 546.

CPU 526, pointing device 528, keyboard 530, microphone 532, printer 534, memory 536, mass memory storage 538, GUI 540, video camera 542, input/output interface 544 and network interface 546 may communicate in a unidirectional manner or a bi-directional manner with each other via a communication channel 548. Communication channel 548 may be configured as a single communication channel or a multiplicity of communication channels.

CPU 526 may be comprised of a single processor or multiple processors. CPU 526 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 536 is used typically to transfer data and instructions to CPU 526 in a bi-directional manner. Memory 536, as discussed previously, may include any suitable computer-readable media, intended for data storage, such as those described above excluding any wired or wireless transmissions unless specifically noted. Mass memory storage 538 may also be coupled bi-directionally to CPU 526 and provides additional data storage capacity and may include any of the computer-readable media described above. Mass memory storage 538 may be used to store programs, data and the like and is typically a secondary storage medium such as a hard disk. It will be appreciated that the information retained within mass memory storage 538, may, in appropriate cases, be incorporated in standard fashion as part of memory 536 as virtual memory.

CPU 526 may be coupled to GUI 540. GUI 540 enables a user to view the operation of computer operating system and software. CPU 526 may be coupled to pointing device 528. Non-limiting examples of pointing device 528 include computer mouse, trackball and touchpad. Pointing device 528 enables a user with the capability to maneuver a computer cursor about the viewing area of GUI 540 and select areas or features in the viewing area of GUI 540. CPU 526 may be coupled to keyboard 530. Keyboard 530 enables a user with the capability to input alphanumeric textual information to CPU 526. CPU 526 may be coupled to microphone 532. Microphone 532 enables audio produced by a user to be recorded, processed and communicated by CPU 526. CPU 526 may be connected to printer 534. Printer 534 enables a user with the capability to print information to a sheet of paper. CPU 526 may be connected to video camera 542. Video camera 542 enables video produced or captured by user to be recorded, processed and communicated by CPU 526.

CPU 526 may also be coupled to input/output interface 544 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 526 optionally may be coupled to network interface 546 which enables communication with an external device such as a database or a computer or telecommunications or internet network using an external connection shown generally as communication channel 516, which may be implemented as a hardwired or wireless communications link using suitable conventional technologies. With such a connection, CPU 526 might receive information from the network, or might output information to a network in the course of performing the method steps described in the teachings of the present invention.

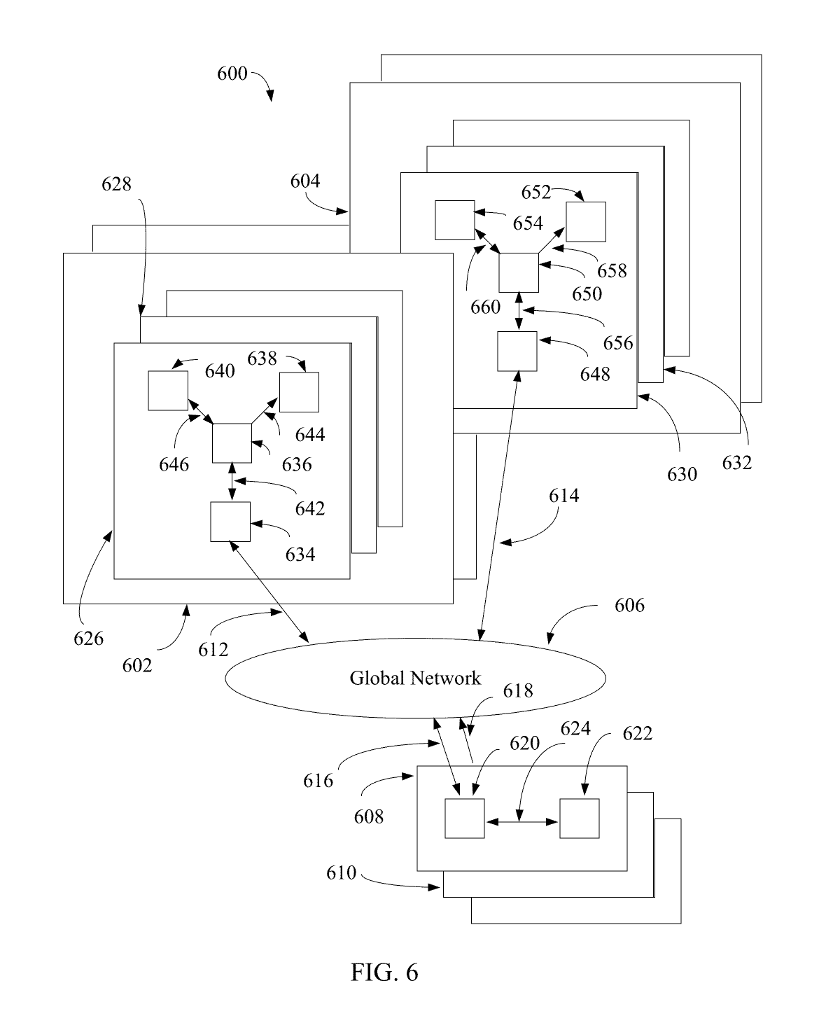

FIG. 6 illustrates a block diagram depicting a conventional client/server communication system.

A communication system 600 includes a multiplicity of networked regions with a sampling of regions denoted as a network region 602 and a network region 604, a global network 606 and a multiplicity of servers with a sampling of servers denoted as a server device 608 and a server device 610.

Network region 602 and network region 604 may operate to represent a network contained within a geographical area or region. Non-limiting examples of representations for the geographical areas for the networked regions may include postal zip codes, telephone area codes, states, counties, cities and countries. Elements within network region 602 and 604 may operate to communicate with external elements within other networked regions or within elements contained within the same network region.

In some implementations, global network 606 may operate as the Internet. It will be understood by those skilled in the art that communication system 600 may take many different forms. Non-limiting examples of forms for communication system 600 include local area networks (LANs), wide area networks (WANs), wired telephone networks, cellular telephone networks or any other network supporting data communication between respective entities via hardwired or wireless communication networks. Global network 606 may operate to transfer information between the various networked elements.

Server device 608 and server device 610 may operate to execute software instructions, store information, support database operations and communicate with other networked elements. Non-limiting examples of software and scripting languages which may be executed on server device 608 and server device 610 include C, C++, C# and Java.

Network region 602 may operate to communicate bi-directionally with global network 606 via a communication channel 612. Network region 604 may operate to communicate bi-directionally with global network 606 via a communication channel 614. Server device 608 may operate to communicate bi-directionally with global network 606 via a communication channel 616. Server device 610 may operate to communicate bi-directionally with global network 606 via a communication channel 618. Network region 602 and 604, global network 606 and server devices 608 and 610 may operate to communicate with each other and with every other networked device located within communication system 600.

Server device 608 includes a networking device 620 and a server 622. Networking device 620 may operate to communicate bi-directionally with global network 606 via communication channel 616 and with server 622 via a communication channel 624. Server 622 may operate to execute software instructions and store information.

Network region 602 includes a multiplicity of clients with a sampling denoted as a client 626 and a client 628. Client 626 includes a networking device 634, a processor 636, a GUI 638 and an interface device 640. Non-limiting examples of devices for GUI 638 include monitors, televisions, cellular telephones, smartphones and PDAs (Personal Digital Assistants). Non-limiting examples of interface device 640 include pointing device, mouse, trackball, scanner and printer. Networking device 634 may communicate bi-directionally with global network 606 via communication channel 612 and with processor 636 via a communication channel 642. GUI 638 may receive information from processor 636 via a communication channel 644 for presentation to a user for viewing. Interface device 640 may operate to send control information to processor 636 and to receive information from processor 636 via a communication channel 646. Network region 604 includes a multiplicity of clients with a sampling denoted as a client 630 and a client 632. Client 630 includes a networking device 648, a processor 650, a GUI 652 and an interface device 654. Non-limiting examples of devices for GUI 638 include monitors, televisions, cellular telephones, smartphones and PDAs (Personal Digital Assistants). Non-limiting examples of interface device 640 include pointing devices, mousse, trackballs, scanners and printers. Networking device 648 may communicate bi-directionally with global network 606 via communication channel 614 and with processor 650 via a communication channel 656. GUI 652 may receive information from processor 650 via a communication channel 658 for presentation to a user for viewing. Interface device 654 may operate to send control information to processor 650 and to receive information from processor 650 via a communication channel 660.

For example, consider the case where a user interfacing with client 626 may want to execute a networked application. A user may enter the IP (Internet Protocol) address for the networked application using interface device 640. The IP address information may be communicated to processor 636 via communication channel 646. Processor 636 may then communicate the IP address information to networking device 634 via communication channel 642. Networking device 634 may then communicate the IP address information to global network 606 via communication channel 612. Global network 606 may then communicate the IP address information to networking device 620 of server device 608 via communication channel 616. Networking device 620 may then communicate the IP address information to server 622 via communication channel 624. Server 622 may receive the IP address information and after processing the IP address information may communicate return information to networking device 620 via communication channel 624. Networking device 620 may communicate the return information to global network 606 via communication channel 616. Global network 606 may communicate the return information to networking device 634 via communication channel 612. Networking device 634 may communicate the return information to processor 636 via communication channel 642. Processor 646 may communicate the return information to GUI 638 via communication channel 644. User may then view the return information on GUI 638.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: interaction of electronic devices through use of lasers, and communication of electronic devices with server.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing wireless communication according to the present invention will be apparent to those skilled in the art. Various aspects of the invention have been described above by way of illustration, and the specific embodiments disclosed are not intended to limit the invention to the particular forms disclosed. The particular implementation of the wireless communication may vary depending upon the particular context or application. By way of example, and not limitation, the wireless communication described in the foregoing were principally directed to cellular device implementations; however, similar techniques may instead be applied to basic specialized devise, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method comprising the steps of:
preparing a message on a first mobile computing device for delivery to an individual in possession of a second mobile computing device in optical view of the first mobile device;
communicating the message, from the first mobile computing device, to at least one common application server for storage thereon;
transmitting at least a part of the message, from the first mobile computing device, encoded in an optical beam for reception by an optical port on the second mobile computing device, the part at least comprising a message identification code, the second mobile computing device being configured to be operable for communicating the received message identification code to the at least one common application server to retrieve the message, in which the message is deliverable to the individual without identifying information of the individual being accessible on the first mobile computing device.

2. The method as recited in claim 1, in which the message further comprises an invitation for the individual to join in an interactive activity being hosted by the at least one common application server.

3. The method as recited in claim 2, in which the interactive activity is configured to be joinable by a plurality of individuals possessing mobile computing devices and having received a message to join the interactive activity.

4. The method as recited in claim 1, in which the second mobile computing device is further configured to be operable, after receipt of the message, to communicate personal information of the individual to the at least one common application server for communication to the first mobile computing device.

5. The method as recited in claim 1, in which the first mobile computing device and the second mobile computing device are located within a venue where an operator of the venue at least in part controls the execution of the steps of communicating and transmitting.

6. The method as recited in claim 5, in which the operator charges a fee for performing the steps of communicating and transmitting.

7. The method as recited in claim 2, in which the interactive activity at least comprises a messaging function between the first and second mobile computing devices communicating through the at least one common application server.

8. The method as recited in claim 1, in which the step of transmitting further uses a laser device in the first mobile computing device.

9. The method as recited in claim 1, in which the optical port is configured to receive a beam from the laser device.

10. A system comprising:
a first mobile computing device being configured to be operable for preparing a message to be delivered to an individual, said first mobile computing device being further configured to be operable for communicating said message for storage, and optically transmitting at least a portion of said message comprising a message identification code;
at least one common application server being configured to be operable for receiving and storing said message;
a second mobile computing device, in possession of the individual, being configured to be operable for receiving said portion of said message, and communicating said message identification code to said at least one common application server for retrieving said message, in which said message is deliverable to the individual without identifying information of the individual being accessible on said first mobile computing device.

11. The system as recited in claim 10, in which said first mobile computing device further comprises a laser device for transmitting said portion of said message, said message further comprising an invitation for the individual to join in an interactive activity being hosted by said at least one common application server, said interactive activity at least comprising a messaging function between said first and second mobile computing devices communicating through said at least one common application server, said interactive activity being further configured to be joinable by a plurality of individuals possessing mobile computing devices and having received a message to join said interactive activity, said second mobile computing device being further configured to be operable, after receipt of said message, for communicating personal information of the individual to said at least one common application server for communication to said first mobile computing device, said second mobile computing device further comprising an optical port being configured to be operable for receiving a beam from said laser device, said first mobile computing device and said second mobile computing device being located within a venue where an operator of the venue at least in part controls and charges a fee for the communicating and transmitting.

12. A non-transitory computer-readable storage medium with an executable program stored thereon, wherein the program instructs one or more processors to perform the following steps:
preparing a message on a first mobile computing device for delivery to an individual in possession of a second mobile computing device in optical view of the first mobile device;
communicating the message, from the first mobile computing device, to at least one common application server for storage thereon;
transmitting at least a part of the message, from the first mobile computing device, encoded in an optical beam for reception by an optical port on the second mobile computing device, the part at least comprising a message identification code, the second mobile computing device being configured to be operable for communicating the received message identification code to the at least one common application server to retrieve the message, in which the message is deliverable to the individual without identifying information of the individual being accessible on the first mobile computing device.

13. The program instructing the processor as recited in claim 12, in which the message further comprises an invitation for the individual to join in an interactive activity being hosted by the at least one common application server.

14. The program instructing the processor as recited in claim 13, in which the interactive activity is configured to be joinable by a plurality of individuals possessing mobile computing devices and having received a message to join the interactive activity.

15. The program instructing the processor as recited in claim 12, in which the second mobile computing device is further configured to be operable, after receipt of the message, to communicate personal information of the individual to the at least one common application server for communication to the first mobile computing device.

16. The program instructing the processor as recited in claim 12, in which the first mobile computing device and the second mobile computing device are located within a venue where an operator of the venue at least in part controls the execution of the steps of communicating and transmitting.

17. The program instructing the processor as recited in claim 16, in which the operator charges a fee for performing the steps of communicating and transmitting.

18. The program instructing the processor as recited in claim 13, in which the interactive activity at least comprises a messaging function between the first and second mobile computing devices communicating through the at least one common application server.

19. The program instructing the processor as recited in claim 12, in which the step of transmitting further uses a laser device in the first mobile computing device.

20. The program instructing the processor as recited in claim 12, in which the optical port is configured to receive a beam from the laser device.
